(19) United States
(12) Patent Application Publication
(10) Pub. No.: US 2007/0194624 A1
(43) Pub. Date: Aug. 23, 2007

(54) SYSTEM FOR THE SUPPLY OF ELECTRICAL ENERGY IN A MOTOR VEHICLE

(75) Inventor: Giancarlo Casellato, Orbassano (IT)

Correspondence Address: SUGHRUE MION, PLLC, 2100 PENNSYLVANIA AVENUE, N.W., SUITE 800, WASHINGTON, DC, 20037, US

(73) Assignee: CRF SOCIETA CONSORTILE PER AZIONI, Orbassano (IT)

(21) Appl. No.: 11/420,886

(22) Filed: Nov. 6, 2006

(30) Foreign Application Priority Data
Oct. 10, 2005 (EP) 05425706.8

(51) Int. Cl. H02H 7/18; H02J 9/00; H02J 7/00

(52) U.S. Cl. 307/10.7; 307/64; 307/66

(57) ABSTRACT

The system comprises: an electrical generator which can be driven by the motor vehicle's engine, a first storage battery which is connected to the generator by means of a power line and is intended to be connected to the normal user devices; and a second battery or auxiliary battery which is connected to the power line and is intended to be connected to the priority user devices. The second battery is connected to the power line by means of a controlled unidirectional dc/dc converter which can permit the transfer of energy solely from the line to the second battery, and with which is associated an electronic control system which is arranged to estimate the charge state of the second battery in accordance with predetermined procedures, and to control the dc/dc converter in a manner such as to regulate the supply of electrical energy from the power line to the second battery so that the estimated charge state of the second battery tends towards a predetermined reference value.

The present invention relates to a system for the supply of electrical energy to electrical/electronic user devices installed in a motor vehicle.

In conventional motor vehicles that are currently in production, the electrical energy required for the on-board electrical/electronic devices is produced by a generator (typically an alternator) driven by the motor vehicle's engine, and is then stored and supplied by (at least) one storage battery and is absorbed by the various on-board user devices or loads in operation.

Naturally, the amount of energy that can be generated on board a motor vehicle is limited and depends on the rate of rotation of the motor-vehicle's engine.

In operation, various conditions may arise in which the amount of energy generated on board is less than the amount of energy that is required by the user devices; in such situations, the “lacking” amount of energy is obtained from the storage battery, the charge of which is correspondingly reduced. If the storage battery is completely discharged, all of the on-board systems cease to operate.

Such a condition is not generally dangerous in a conventional motor vehicle without “drive-by-wire” systems, in particular without “by-wire” steering and braking systems.

In the above-mentioned conventional motor vehicles, the capacity of the electrical-energy storage system (the battery) is selected on the basis of conventional electrical-balance analysis methods which relate to predefined standard operating cycles and which aim to reduce greatly the probability of situations occurring in practice, in which the motor-vehicle is not available due to a deficit of electrical energy.

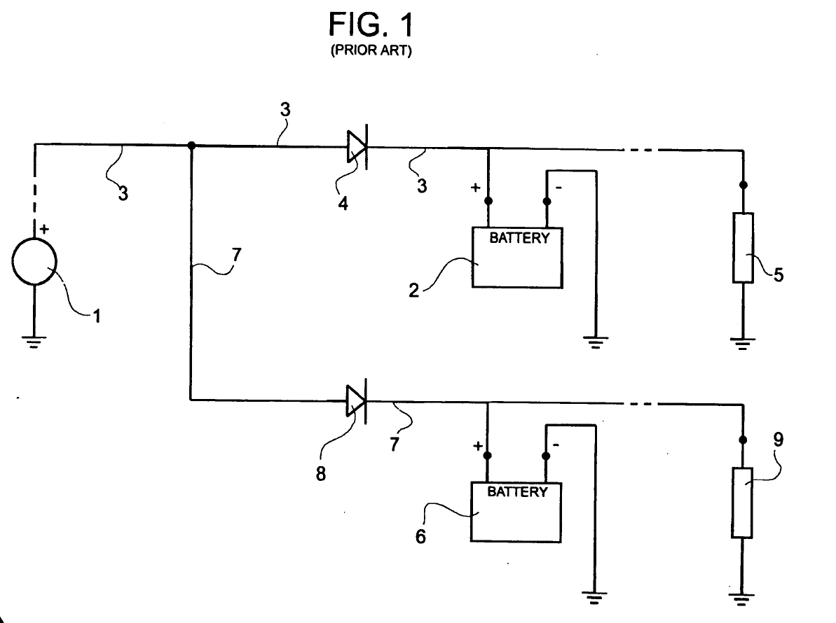

In motor vehicles with by-wire steering and/or by-wire braking systems, a lack of electrical energy is liable to lead to failure of the control and electrically-operated systems, which has a very great impact on safety. In such vehicles, the increase in the demand for electrical energy due to the introduction of by-wire systems renders the on-board electrical balance even more critical because the capacity of the on-board generator cannot be increased indiscriminately at will. In vehicles with by-wire steering and braking, a selection of the capacity of the energy system based on conventional methods does not ensure that there will not be situations in which the electrical balance becomes negative for sufficient time to put the system in crisis. In these vehicles, the use of electrical-energy supply systems with apparently separate architectures such as that shown schematically in FIG. 1 of the appended drawings does not ensure safety with respect to the problem outlined above.

The system according to FIG. 1 comprises an electrical generator 1 (an alternator) which can be driven by the internal combustion engine (not shown) of the motor vehicle. A first storage battery, indicated 2, is connected to the generator 1 by means of an electrical power line 3 in which a diode 4 is interposed. The battery 2 is intended to be operatively connected to “normal”, that is non-priority electrical/electronic user devices which are represented generally in FIG. 1 by a generic load indicated 5. The normal, that is, non-priority devices or loads comprise substantially all of the on-board electrical loads with the exclusion of the electrical/electronic devices forming part of by-wire steering and/or braking systems or of other by-wire systems the functionality of which is essential for safe driving of the motor vehicle. These latter devices or loads, hereinafter defined as priority loads, are represented generally in the diagram of FIG. 1 by a generic load 9 and are intended to be operatively connected to (at least) one second storage battery or auxiliary battery 6 which is connected to the electrical power line 3 by means of a branched electrical line 7 in which a diode 8 is interposed.

With the electrical-energy supply system according to FIG. 1, the battery 2 for the normal loads and the battery 6 for the priority loads share the energy produced by the generator 1 to a degree which varies substantially in inverse proportion to their respective charge states. In negative energy-balance situations, both of the storage systems (the batteries 2 and 6) are discharged with the possibility that energy-fault conditions may occur, with worrying impacts on the safe handling of the motor vehicle.

An object of the present invention is to provide a system for the supply of electrical energy to electrical/electronic devices installed on board a motor vehicle, which system eliminates or at least mitigates the above-described disadvantages of systems of the prior art.

These and other objects are achieved, according to the invention, by a system of the type defined above, characterized in that
the second battery or auxiliary battery is connected to the electrical power line by means of
a controlled unidirectional dc/dc converter which permits the transfer of energy solely from the electrical power line to the second battery and with which is associated
an electronic control system which is arranged
to estimate the charge state of the second battery in accordance with predetermined procedures, and
to control the dc/dc converter in a manner such as to regulate the supply of electrical energy from the power line to the second battery so that the estimated charge state of the second battery tends towards a predetermined reference value.

The system for the supply of electrical energy according to the invention can therefore ensure the supply of energy to the priority loads (by-wire systems) in negative energy-balance conditions. These priority devices or loads can thus “survive” the occurrence of an energy black-out of the storage system associated with the “normal” loads, at least for some time.

Further characteristics and advantages of the invention will become clear from the following detailed description which is given purely by way of non-limiting example, with reference to the appended drawings, in which:

FIG. 1, which has already been described, is a diagram of an on-board electrical-energy supply system of a motor vehicle of the prior art;

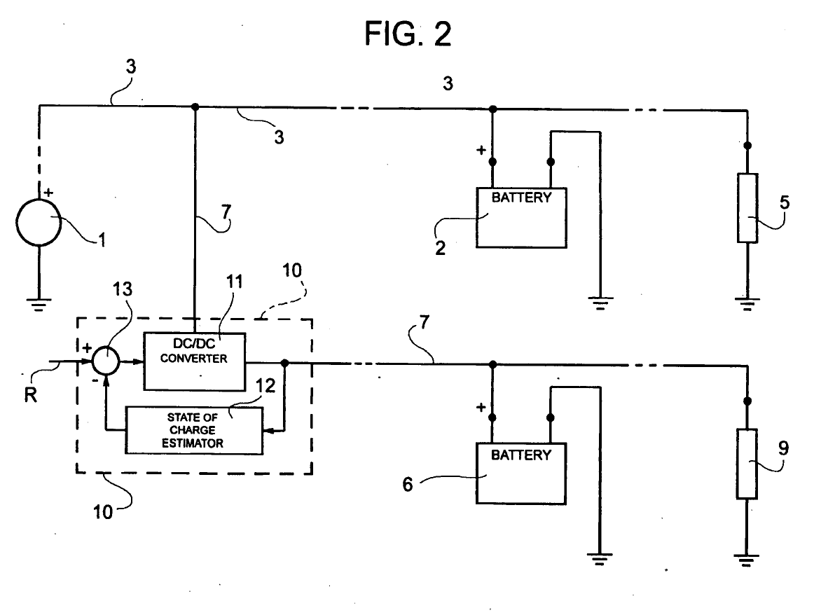

FIG. 2 is an electrical diagram of an on-board electrical-energy supply system of a motor vehicle according to the present invention; and

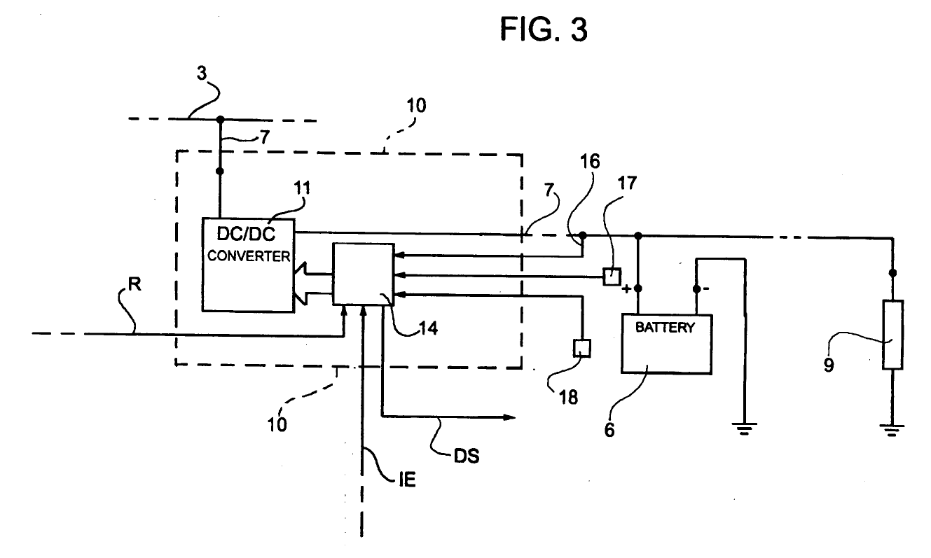

FIG. 3 is a partial electrical diagram which shows an embodiment of a portion of the system according to FIG. 2.

In FIGS. 2 and 3, parts which are identical or substantially equivalent to parts that have already been described with reference to FIG. 1 have again been attributed the same reference numerals as were used above.

The system for the supply of electrical energy according to the invention which is shown in the diagram of FIG. 2 thus comprises a generator 1 (an alternator) which is driven operatively by the internal combustion engine (not shown) of the motor vehicle. The generator 1 is connected, by means of an electrical power line 3, to the battery 2 associated with the normal (non-priority) user devices or loads 5.

A branch line 7 branches from the electrical power line 3 to supply electrical energy to the battery 6 which is associated with the priority electrical/electronic user devices (loads) 9.

A control unit, generally indicated 10 in FIGS. 2 and 3, is interposed in the electrical line 7.

This unit comprises a controlled unidirectional dc/dc converter 11 of which the input is connected to the electrical power line 3 and the output is connected to the auxiliary battery 6. In operation, the converter 11 permits a flow of energy from the generator 1 to the auxiliary battery 6 through the line 7 but not in the opposite direction.

An electronic control system is associated with the dc/dc converter 11. According to the diagram of FIG. 2, the control system comprises an estimator 12 which is arranged to estimate the charge state of the auxiliary battery 6 in accordance with predetermined procedures, for example, on the basis of the information represented by the voltage of the battery and optionally also of the current delivered in operation and, again optionally, also in dependence on the battery temperature. The estimator 12 provides output signals or data that are representative of the estimated charge state of the auxiliary battery 6 to an algebraic adder 13. The adder receives, at a further input, reference signals or data R that are indicative of a charge state of the auxiliary battery 6 which the control unit 10 as a whole should tend to keep substantially constant. The device 13 drives the dc/dc converter 11 in dependence on the “error”, that is, on the difference between the reference R and the estimated charge state of the auxiliary battery 6 in a manner such as correspondingly to regulate the flow of energy from the generator 1 to the battery 6 so as to tend to keep the charge state of that battery at the desired reference value.

The control system associated with the dc/dc converter 11 is therefore such as to modulate its power, that is, the energy flow per unit of time, in order to keep the charge state of the auxiliary battery 6 at the desired value. The regulation or modulation may be continuous, that is, substantially proportional to the “error” between the reference R and the estimated charge state, or may be of the ON/OFF type.

The estimator 12 may be formed with the use of extremely simple algorithms based substantially on the reading of the voltage of the auxiliary battery 6, or by very sophisticated algorithms which can estimate the charge state of the battery in accordance with a plurality of operative parameters.

With reference to FIG. 3, in one implementation, the estimator 12 and the algebraic adder 13 are formed functionally by a single circuit device 14 which is arranged to drive the dc/dc converter 11 and, in particular, to modulate its power. The circuit device 14 receives the reference R. The circuit device may also receive information and/or enabling signals or data IE from an electronic unit of a control system of the vehicle (not shown).

The device 14 is also advantageously arranged to emit diagnosis signals DS, for example, for the control system of the vehicle, to indicate the occurrence of fault events such as a permanent breakdown of one of the components with consequent loss of the recharging function of the auxiliary battery 6, or a condition in which it is impossible to reach the battery charge-state target value, for example, because of transitory high intensity phenomena or because of a lack of adequate voltage/power levels in the input electrical line 3.

The power of the dc/dc converter 11 may be modulated by the device 14 in accordance with the voltage of the auxiliary battery 6 detected, for example, by means of a connection 16, with the intensity of the current delivered by the battery 6 in operation detected, for example, by means of a suitable sensor 17 (such as a shunt resistor, a Hall-effect sensor, etc), and in accordance with the temperature of the battery 6 detected, for example, by means of a probe 18.

Naturally, the principle of the invention remaining the same, the forms of embodiment and details of construction may be varied widely with respect to those described and illustrated purely by way of non-limiting example, without thereby departing from the scope of the invention as defined in the appended claims.

What is claimed is:

1. A system for the supply of electrical energy to electrical/electronic user devices installed in a motor vehicle, the user devices comprising predetermined priority user devices and normal, non-priority user devices, the system comprising
an electrical generator which can be driven by the motor vehicle's engine,
a first storage battery which is connected to the generator by means of an electrical power line and is intended to be connected operatively to the normal user devices; and
a second storage battery or auxiliary battery which is connected to the electrical power line and is intended to be connected operatively to the priority user devices;
the second battery being connected to the electrical power line by means of
a controlled unidirectional dc/dc converter which is adapted to permit the transfer of energy solely from the electrical line to the second battery, and with which is associated
an electronic control system which is arranged to estimate the charge state of the second battery in accordance with predetermined procedures, and
to control the dc/dc converter in a manner such as to regulate the supply of electrical energy from the power line to the second battery so that the estimated charge state of the second battery tends towards a predetermined reference value.

2. A system according to claim 1 in which the control system is arranged to regulate the operation of the dc/dc converter continuously in accordance with the difference or error between the reference value and the estimated charge state of the second battery.

3. A system according to claim 1 in which the control system is arranged to regulate the operation of the dc/dc converter in an on-off manner in accordance with the difference or error between the reference value and the estimated charge state of the second battery.

4. A system according to claim 1 in which the control system is arranged to estimate the charge state of the second battery in accordance with the voltage of the second battery.

5. A system according to claim 4 in which the control system is arranged to estimate the charge state of the second battery also in accordance with the intensity of the current delivered by the second battery.

6. A system according to claim 4 in which the control system is arranged to estimate the charge state of the second battery also in accordance with the working temperature of the second battery.
